(19) United States
(12) Patent Application Publication
(10) Pub. No.: US 2026/0061445 A1
(43) Pub. Date: Mar. 5, 2026

(54) SYSTEM AND METHOD FOR CONTINUOUS POWDER DELIVERY FOR ELECTROSTATIC COATING

(71) Applicant: PowderCoil Technologies, LLC, Crown Point, IN (US)

(72) Inventors: Robert McShane, Evergreen Park, IL (US); Alex Duchak, Frankfort, IL (US); Steve Murray, Roselle, IL (US); Jeremy Murray, Dundee, IL (US); Parakh Kantawala, Chicago, IL (US); Margaret Beauchamp, Deer Path, IL (US)

(21) Appl. No.: 19/319,031

(22) Filed: Sep. 4, 2025

Related U.S. Application Data
(60) Provisional application No. 63/690,724, filed on Sep. 4, 2024.

(51) Int. Cl. B05B 12/00; B05B 5/16

(52) U.S. Cl. CPC B05B 12/008; B05B 5/1683

(57) ABSTRACT

The present disclosure generally relates to a system for storing and continuously supplying a powder or granular material for use in an electrostatic coating system or process, and in particular to one or more apparatuses for precisely supplying a continuous fluidized stream of granules. What is also contemplated is embodiments wherein one or more apparatuses include a powder feed hopper for receiving a fine granular material and delivering a precise and continuous fine granular material flow to a downstream powder coating system or process. In embodiments, the one or more apparatuses include a tilt table for precisely managing the bulk fine granular material stored in containers, such as a Gaylord container, by ensuring a continuous, precise, and controlled supply of fine granular material to a downstream powder coating system or process.

### RELATED APPLICATION AND INCORPORATION BY REFERENCE

This application claims benefit of and priority to U.S. Provisional Patent Application Ser. No. 63/690,724, filed Sep. 4, 2024. The foregoing application is hereby incorporated by reference

### COPYRIGHT NOTIFICATION

Portions of this patent application contain materials that are subject to copyright protection. The copyright owner has no objection to the facsimile reproduction by anyone of the patent document, or the patent disclosure, as it appears in the U.S. Patent and Trademark Office, but otherwise reserves all copyright rights whatsoever.

### FIELD OF THE DISCLOSURE.

The present invention generally relates to a system for storing and continuously supplying a powder or granules for use in an electrostatic coating system or process, and in particular to one or more apparatuses for precisely supplying a continuous stream of granules.

### BACKGROUND OF THE DISCLOSURE

During the industrial coating process, wide varieties of media are covered with different surface materials. For example, paper may be covered with starch solutions for improved heat resistance characteristics, and metal sheeting may be coated with paint or latex for aesthetic value or corrosion protection of oxidizing surfaces. The coating of materials on media is widely used in the industry, and improved, cost-effective apparatuses, methods, and devices are continuously sought. The use of coating liquids may utilize volatile solvents and require drying processes that create gas wastes requiring treatment. Apparatuses and methods for applying coating material in powder form to a medium do not suffer from the above shortcomings. Powders must adhere temporarily to the medium and be uniformly spread to prevent bumps or problems during post-treatment operations. Once applied to a medium, powders may require post-treatment operations such as baking to fix the powder permanently on the surface.

One of the known ways to adhere a powder to a surface without adding unnecessary agents or adhesives is by using the electrostatic adhering capacity of a charged stream of particles made from a powder suspended in a gas and placed in contact with a medium that has a different electrical energy or is grounded. Coulomb's law provides that electrostatic force felt by two bodies charged with the same polarity charge is a repulsive force, and the force felt by two bodies charged with opposite polarity is an attractive force. Once the powder particles in a stream are charged, either by removing or adding surface electrons, the particles are then drawn by the electromagnetic force to a grounded medium in proportion to Coulomb's law. Another advantage of electrostatic charging of a stream of particles is the creation of repulsion forces between neighboring particles in the stream placed at equivalent energy to aid in the spatial distribution of the particles within the stream of particles. Additionally, charged particles are drawn by a stronger electrostatic force on a surface where other particles have not yet attached.

Electrostatic coating requires consistent and precise control of the granules being transported throughout the process line. Existing approaches to storing and transporting granules struggle to prevent particle segregation, settlement, and caking. To solve these issues, typical solutions include aeration of the granules to create a fluidized material. Existing systems, however, fail to provide the precise control needed to maintain a fluidized flow of material because the bulk density of fine granular material will have a low and non-uniform density when exiting a container, bin, feed hopper, etc. Thus, when aerated, the fine granular material is more likely to segregate. What is needed is an improved apparatus that provides precise control of the fluidized flow throughout the entire fine granular transportation process.

Furthermore, existing systems also fail to allow for precise and continuous flow. Existing systems tend to temporarily run aeration processes to fluidize a fine granular material to transport from one system to another in discrete operations. When a pause in the fine granular transporting process is experienced, the fluidized material becomes cohesive and difficult to refluidize. What is needed is an improved apparatus that provides for precise and continuous flow of the fluidized material throughout the entire fine granular transportation process which decreases the likelihood of segregation, settlement, and caking.

### BRIEF SUMMARY OF THE DISCLOSURE

This summary is provided to introduce a selection of concepts in a simplified form that are further described in the detailed description of the disclosure. This summary is not intended to identify key or essential inventive concepts of the claimed subject matter, nor is it intended for determining the scope of the claimed subject matter.

The present invention generally relates to a system for storing and continuously supplying a powder or granular material for use in an electrostatic coating system or process, and in particular to one or more apparatuses for precisely supplying a continuous stream of granules. In embodiments, the one or more apparatuses includes a powder feed hopper for receiving a fine granular material and delivering a precise and continuous fine granular material flow to a downstream powder coating system or process. In embodiments, the one or more apparatuses include a tilt table for precisely managing the bulk fine granular material stored in containers, such as a Gaylord container, by ensuring a continuous, precise, and controlled supply of fine granular material to a downstream powder coating system or process.

In embodiments, discrete control mechanisms are used to adjust various portions of the powder feed hopper and tilt table systems to create a seamless and continuous fine granular, such as powder, delivery system.

The present disclosure relates to an in-line industrial device able to create a seamless and continuous fine granular delivery system by successively controlling a plurality of parameters, including the above-mentioned novel features, such as (but not limited to), in various embodiments, the amount of aeration inside the powder feed hopper, the output flowrate of the feed pumps, the pressure inside the powder feed hopper, the pressure in the powder lines, temperature in various components of the apparatus, ambient temperature, measured pressure at various locations in the apparatus, and the humidity within the powder feed hopper. The in-line industrial device includes various sensors, including but not limited to, pressure sensors, flowmeters, pressure regulators, temperature sensors, humidity sensors, vibrational sensors, moisture sensors, and level sensors.

### BRIEF DESCRIPTION OF THE SEVERAL VIEWS OF THE DRAWINGS

The foregoing summary, as well as the following detailed description of the disclosure, is better understood when read in conjunction with the appended drawings. For the purpose of illustrating the disclosure, exemplary constructions of the inventions of the disclosure are shown in the drawings. However, the disclosure and the inventions herein are not limited to the specific methods and instrumentalities disclosed herein.

FIG. 1 is a front perspective view of a powder feed hopper system in accordance with an embodiment of the present disclosure.

FIG. 2 is a side perspective view of the powder feed hopper system of FIG. 1 in accordance with an embodiment of the present disclosure.

FIG. 3 is a top view of the powder feed hopper system of FIG. 1 in accordance with an embodiment of the present disclosure.

FIG. 4 is a first side view of a tilt table of the powder delivery system in accordance with an embodiment of the present disclosure.

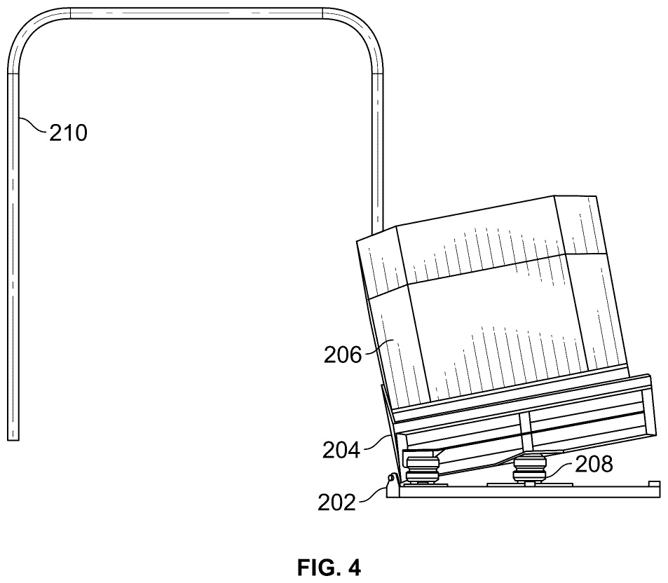

FIG. 5 is a second side view of a tilt table of the powder delivery system of FIG. 4 in accordance with an embodiment of the present disclosure.

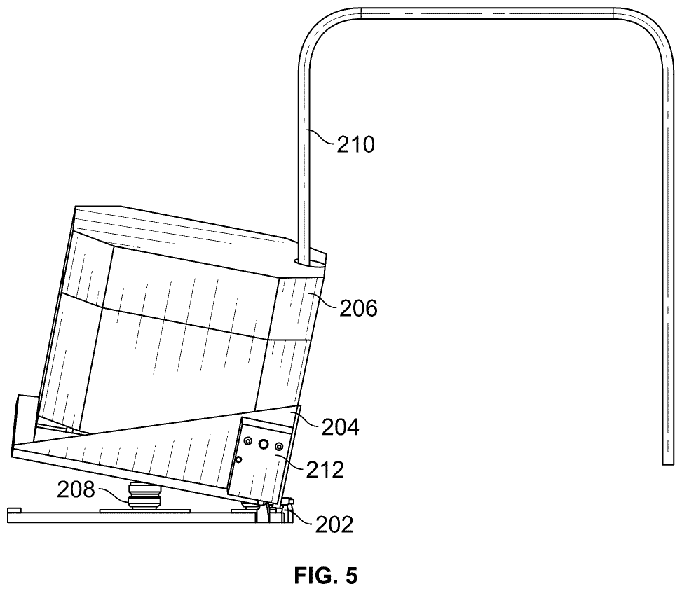

FIG. 6 is a top view of a tilt table of the powder delivery system of FIG. 4 in accordance with an embodiment of the present disclosure.

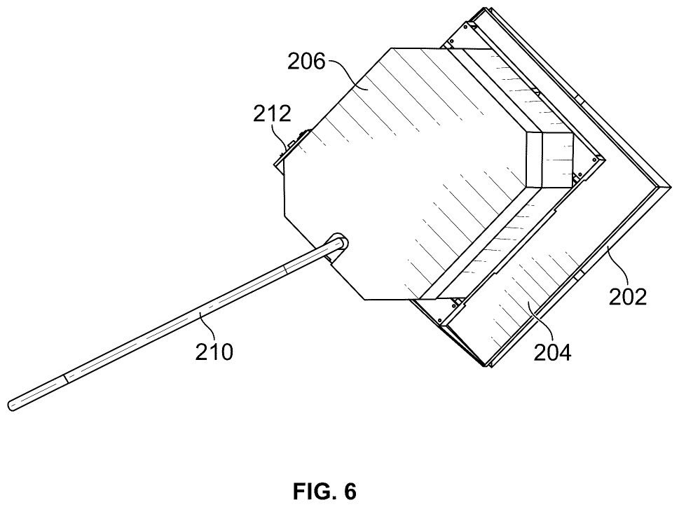

### DETAILED DESCRIPTION OF THE DISCLOSURE

The following disclosure as a whole may be best understood by reference to the provided detailed description when read in conjunction with the accompanying drawings, drawing description, abstract, background, field of the disclosure, and associated headings. Identical reference numerals when found on different figures identify the same elements or a functionally equivalent element. The elements listed in the abstract are not referenced but nevertheless refer by association to the elements of the detailed description and associated disclosure.

In the following detailed description, reference is made to the accompanying drawings that show, by way of illustration, a possible industrial embodiment of the disclosure centered around an improved powder feed hopper. This embodiment is described with detail sufficient to enable one of ordinary skill in the art to practice the disclosure. It is understood that each subfeature or element described in this embodiment of the disclosure, although unique, is not necessarily exclusive and can be combined differently and in a plurality of other possible embodiments because they show novel features. It is understood that the location and arrangement of individual elements, such as geometrical parameters within each disclosed embodiment, may be modified without departing from the spirit and scope of the disclosure. In addition, this disclosed embodiment can be modified based on a plurality of industrial and commercial necessities, such as, in a nonlimiting example, a large-scale coating process. The disclosed apparatus can be modified according to known design parameters to implement this disclosure within these specific types of operation. Other variations will also be recognized by one of ordinary skill in the art. The following detailed description is, therefore, not to be taken in a limiting sense.

### Powder Feed Hopper

The present disclosure relates to a powder feed hopper 100, and its component parts as shown in the associated figures, for storing and continuously supplying a powder or granular material for use in an electrostatic coating system or process, and in particular to one or more apparatuses for precisely supplying a continuous stream of granules.

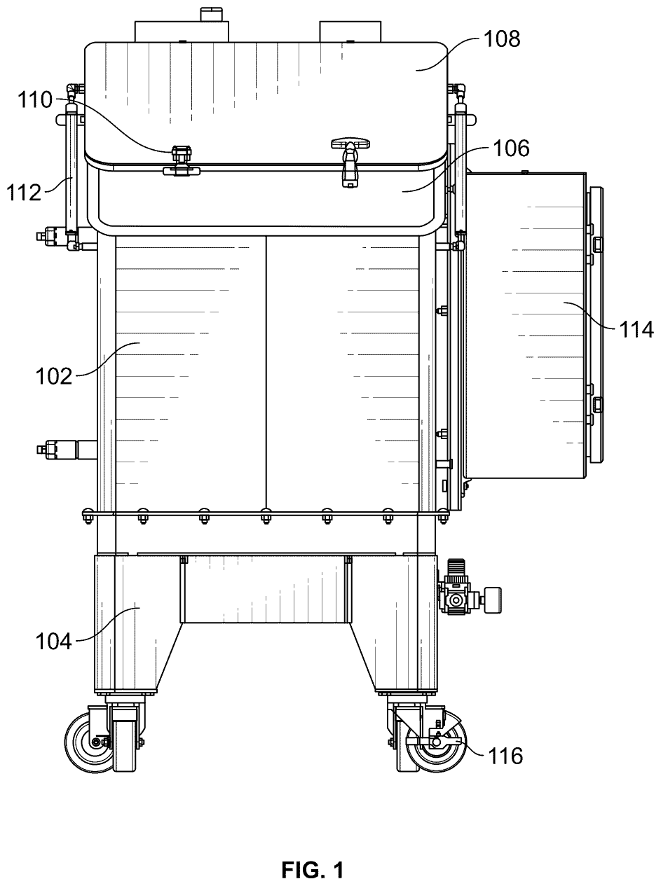

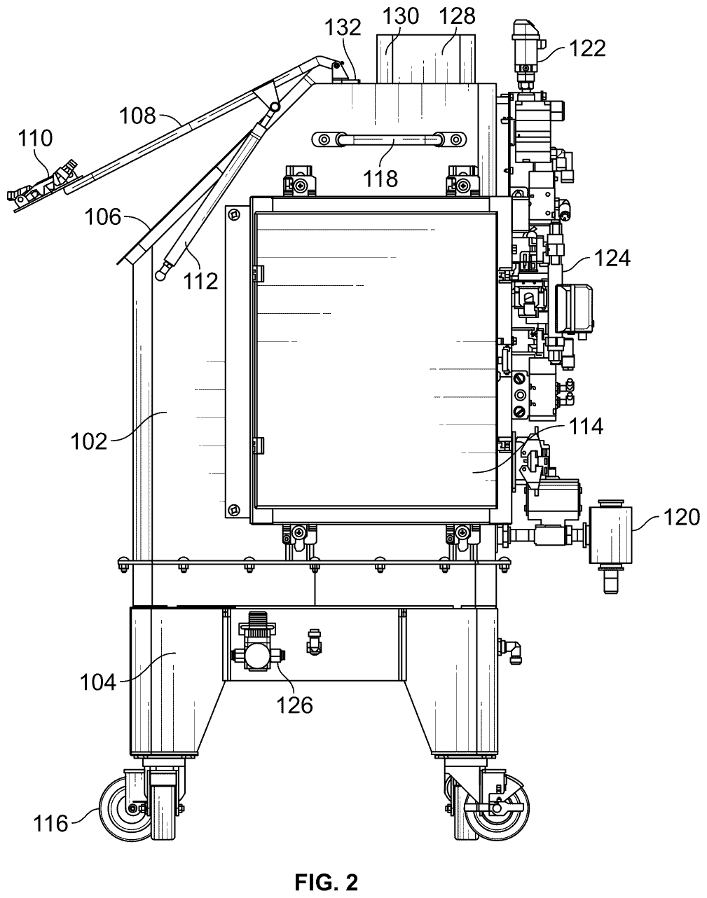

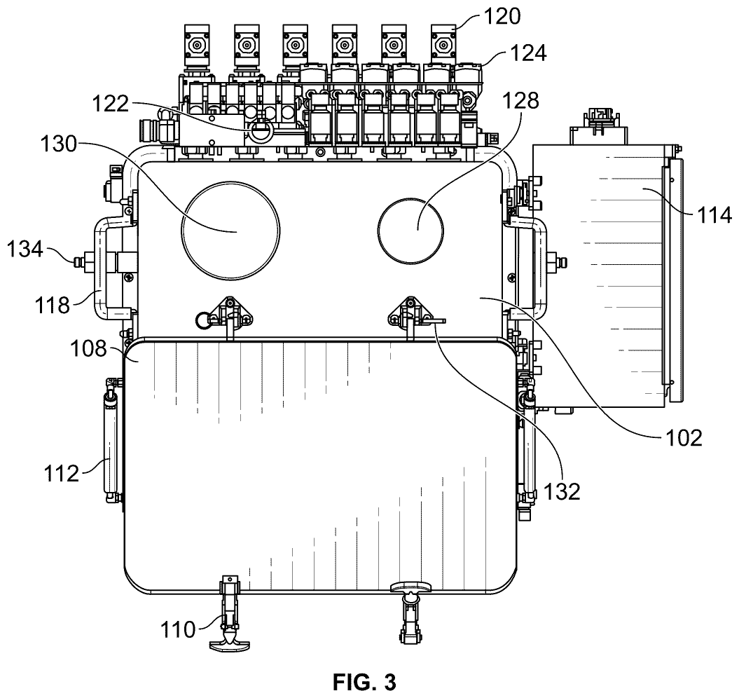

The powder feed hopper 100 shown in FIGS. 1-3 includes a hopper or enclosure 102, having handles 118, that is coupled to a base 104 that is mounted on casters 116. As stated above, existing approaches to storing and transporting granules struggle to prevent particle segregation, settlement, and caking. The hopper 102 is configured with smooth internal contours that eliminate any sharp corners or shelves. These internal smooth internal contours help to prevent powder accumulation, particle segregation, settlement, and caking.

The hopper 102 includes an opening 106, having hinges 132, opposite of the base 104 that allows for inspection and maintenance of the hopper 102. The opening 106 is secured using lid 108 and latches 110. The lid 108 is coupled to a gas spring actuated door strut 112 that assists in the opening and holding open of lid 108. A control box 114 is coupled to one of the sides of the hopper 102. The control box 114 includes various control components, such as PLCs, sensors, displays, etc., that are used to control the powder feed hopper 100.

The powder feed hopper 100 includes a plurality of Venturi-style feed pumps 120 that are configured to supply a precise and continuous flow of fine granular material to a downstream apparatus. The plurality of feed pumps 120 each include a shutoff valve that when actuated, prevents the flow of fine granular material through the plurality of feed pumps 120. The plurality of feed pumps 120 are configured to be evenly spaced to allow for consistent and controlled powder dispersion. In a preferred embodiment, the plurality of feed pumps 120 consists of six Venturi-style feed pumps. In another embodiment, the plurality of feed pumps 120 consists of eight Venturi-style feed pumps. The number of feed pumps 120 is critical to the even drawing of the fine granular material from the hopper 102 to the downstream process. Without even spacing, the fine granular material will experience segregation, settlement, caking, or uneven drawing of the material. This leads to the backing up of fine granular material leading to overfilling of the hopper 102. This leads to higher shutdown (idle line costs) and maintenance costs. It will be understood by one of skill in the art that the number of feed pumps may vary based on the specific requirements of the downstream apparatus. In alternative embodiments, the number of feed pumps ranges from two to ten pumps based on the particular requirements of the downstream apparatus. In yet other embodiments, more or fewer pumps may be used.

The air inlets of each of the plurality of feed pumps 120 are monitored by a pressure sensor 122 and flowmeter 124 that monitors the pressure and flowrate of air supplied to the plurality of feed pumps 120. The control box 114 monitors the pressure and flow readings provided by the pressure sensor 122 and flowrate 124 to determine the proper lbs/min of air to supply the plurality of feed pumps 120 to ensure that the fine granular material is effectively aerated for transport and that the desired amount of fine granular material is transported to the downstream apparatus.

The hopper 102 also includes a vent or exhaust port 128 that is connected to control box 114 to release excess air from the hopper 102 during operation in order to maintain optimal operating conditions within the hopper 102. Releasing excess air from the hopper 102 may be triggered by a determination that the pressure within the hopper 102 is too high/low, the humidity within the hopper 102 is too high/low, or the temperature within the hopper 102 is too high/low.

In an embodiment, the powder feed hopper 100 includes a powder intake 130 that receives a supply of fine granular material from the one or more tilt tables via a vacuum transport system or powder line 210.

In an embodiment, the powder feed hopper 100 includes a level sensor 134 connected to control box 114. The level sensor 134 is configured to determine the level of fine granular material contained within the hopper 102. The control box 114 is configured to monitor for a variety of predetermined set levels. Using these predetermined set levels, the control box 114 activates or deactivates the powder line 210. The controller box 114 may also be configured to activate or deactivate various upstream or downstream apparatuses, such as a tilt table or electrostatic coating system.

The powder feed hopper 100 includes an integrated weighing scale 136 (not shown) that is connected to the control box 114 to allow for precise monitoring of powder levels within the hopper 102. The control box 114 is configured to monitor for a variety of predetermined set levels. Using these predetermined set levels, the control box 114 activates or deactivates the powder line 210. The controller box 114 may also be configured to activate or deactivate various upstream or downstream apparatuses, such as a tilt table or electrostatic coating system.

In an embodiment, the control box 114 includes a display 138 (not shown) configured to display a human machine interface (“HMI”) containing information on the plurality of feed pumps 120, pressure sensor 122 and flowmeter 124, pressure regulator 126, level sensor 134, weighing scale 136, exhaust port 128, air supply system, powder line 210, powder management system 200, and downstream apparatus. A user may interact with the HMI and display 138 to set various parameters of the plurality of feed pumps 120, pressure sensor 122 and flowmeter 124, pressure regulator 126, level sensor 134, weighing scale 136, exhaust port 128, air supply system, powder line 210, powder management system 200, and downstream apparatus.

In an embodiment, the powder feed hopper 100 is equipped with an RFID tag 140 (not shown) that enables each powder feed hopper 100 to be uniquely identified by the downstream apparatus's RFID receiver. The RFID tag 140 may include information such as a unique identifier, system specification, and material specifications. The downstream apparatus is configured to utilize the information included in the RFID tag 140 to set system parameters with the downstream apparatus. Additionally, the downstream apparatus's control system, including PLCS, may communicate to the control box 114 for the powder feed hopper 100 in response to receiving the information contained within RFID tag 140 in order to reconfigure various system parameters for the powder feed hopper 100, such as the flowrate, allowed pressure, humidity levels, etc.

In an embodiment, the powder feed hopper 100 includes a fluidizing plate 142 (not shown) that is fluidly connected to the air supply of the powder feed hopper 100 and a pressure regulator 126. The fluidizing plate 142 can be made from a ultra-high molecular weight polyethylene (“UHMW PE”) that allows for uniform air distribution for diffusing, aerating, and fluidizing fine granular materials. The fluidizing plate 142 is controlled via the control box 114, using the pressure regulator 126 to ensure that the fine granular material within the powder feed hopper 100 is aerated. The control box 114 can adjust the amount of air supplied to the fluidizing plate 142 to adjust the fluidity of the fine granular material within the hopper 102. By adjusting the fluidity of the fine granular material within the hopper 102, the powder feed hopper 100 can maintain a continuous and precise flow of fine granular material.

In operation, the powder feed hopper 100 receives a fine granular material from one or more upstream powder management systems 200, described below, via the intake 130. The powder feed hopper 100 monitors the level of the fine granular material contained within the hopper 102 using level sensor 134 and weighing scale 136. Depending on the level, or amount, of fine granular material within the hopper 102, the powder feed hopper 100 sends a activation/deactivation command to one or more upstream powder management systems 200 and powder line 210. The powder feed hopper 100 utilizes the fluidizing plate 142 to maintain a fluidized state within the fine granular material. Ensuring that the fine granular material maintains a fluidized state helps to prevent the likelihood of segregation, settlement, and caking.

After the fine granular material is aerated, the powder feed hopper 100 dispenses the fine granular material to a downstream apparatus, such as an electrostatic coating system via the plurality of feed pumps 120.

The powder feed hopper 100 may include a vibration sensor 144. The vibration sensor 144 monitors the vibration of the components of the powder feed hopper 100 to determine if various events have occurred. The vibration sensor 144 may also be used to perform vibrational analysis on the various components of the powder feed hopper 100 to determine when a component is reaching the end of its life or needs maintenance. For example, the vibration sensor 144 may indicate that the feed pumps 120 are reaching the end of life.

In an embodiment, the powder feed hopper 100 may include a temperature and humidity sensor 146. The temperature and humidity sensor 146 may be configured to monitor the temperature and humidity within and outside the hopper 102. Fine granular material is prone to segregation, settlement, and caking; using the temperature and humidity sensor 146, the powder feed hopper 100 can increase the air supply to the fluidizing plate 142, one or more feed pumps 120, or any other component to resist such segregation, settlement, and caking.

### Powder Management System

As described above, in an embodiment, the powder feed hopper 100 is coupled to one or more powder management systems 200. The powder management system 200 manages the bulk fine granular material stored in a Gaylord container 206. The powder management system 200 includes a base 202 coupled to a tilt table 204. The tilt table 204 is connected to a control box 212 that actuates airbags 208. The powder management system 200 is configured to hold a Gaylord container 206 and tilt the Gaylord container 206 using airbags 208 to ensure a continuous and precise flow of fine granular material to powder line 210.

Control box 212 is connected to a tilt sensor 214 (not shown), pressure sensor 216 (not shown), and flowmeter 218 (not shown). The control box 212 monitors the tilt sensor 214, pressure sensor 216, and flowmeter 218 to adjust the amount of air within the airbags 208 and the flowrate of the powder line 210.

The powder management system 200 may include a vibration sensor 220. The vibration sensor 220 monitors the vibration of the components of the powder management system 200 to determine if various events have occurred. For example, the vibration sensor 220 may indicate that the Gaylord container 206 has experienced a sudden jolt that could cause an uneven flow or spillage. The vibration sensor 220 may also be used to perform vibrational analysis on the various components of the powder management system 200 to determine when a component is reaching the end of its life or needs maintenance. The vibration sensor 220 may also be used to determine if there is a clog or caking within the powder management system 200 or powder line 210.

In an embodiment, the powder management system 200 may include a temperature and humidity sensor 222. The temperature and humidity sensor 222 may be configured to monitor the temperature and humidity within and outside the Gaylord container 206. Fine granular material is prone to segregation, settlement, and caking; using the temperature and humidity sensor 222, the powder management system 200 can increase the air supply to the powder line 210, increase/decrease the tilt angle, or adjust any other component to resist such segregation, settlement, and caking.

### Integrated Control of the Powder Feed Hopper and Tilt Table

The powder feed hopper 100 and powder management system 200 work together to provide a seamless and continuous flow of fine granular material to downstream apparatuses, such as an electrostatic coating system. As the Gaylord container 206 is tilted using the tilt table 204, the fine granular material within the Gaylord container 206 enters the vacuum transport system or powder line 210. The angle of tilt is precisely controlled by the powder feed hopper 100 and powder management system 200 to ensure that the powder line 210 provides the proper amount of fine granular material to the powder feed hopper 100. Once within the powder feed hopper 100, the fine granular material is kept aerated and fluidized as the plurality of feed pumps 120 draws the fine granular material from the hopper 102. The drawing of the fine granular material from the hopper 102 is finely controlled by the various sensors of the systems to ensure that the proper flow rate of the fine granular material is maintained in real time.

In the event of a low material level detected by level sensor 134 in the hopper 102, the level sensor 134 triggers the activation of the powder line 210, which refills the hopper 102 from the Gaylord container 206, ensuring continuous and uninterrupted operation. This integrated approach maximizes efficiency, minimizes waste, and ensures the highest quality in powder coating applications.

The powder feed hopper 100 and powder management system 200 includes a batch planner 148 (not shown) the batch planner 148 receives batch information from a user, either using display 138 or via a remote computer connected the internet or internal network. The batch information includes information related to the fine granular material and its application to a strip of steel during the electrostatic coating process such as, the desired batch recipe consisting of a mixture of fine granular materials, the desired flowrate outputted by the plurality of feed pumps 120, the amount of steel to be electrostatically coated, information stored on the RFID tags 140, the time the batch should start, the desired ending time for the batch, the desired temperature or humidity of the batch, the amount of fine granular material per minute. The batch planner 148 can automatically determine the optimal daily, or weekly, production plan based on orders received by the batch planner 148 by comparing the requirements of each order to the batch information and RFID tags 140. Additionally, the batch planner 148 may display a series of action items to a user to instruct the user what steps or parameters of the powder feed hopper 100, downstream electrostatic coating process, and powder management system 200 need to be completed by the user to perform the target batch recipe. For example, the batch planner may indicate to a user which powder feed hopper 100 is needed to prepare for the next batch or indicate that a certain amount of additive is to be added depending on the batch recipe.

The drawing of the fine granular material from the hopper 102 is also finely controlled by the film thickness sensors 150 (not shown) of the downstream electrostatic coating system to ensure that the proper flow rate of the fine granular material is maintained in real time. The film thickness sensor 150 monitors the thickness of the fine granular coating applied to a sheet of material during the downstream electrostatic coating process.

The foregoing examples have been provided merely for the purpose of explanation and are in no way to be construed as limiting of the present invention disclosed herein. While the invention has been described with reference to various embodiments, it is understood that the words that have been used herein are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods, and uses, such as are within the scope of the appended claims. Those skilled in the art, having the benefit of the teachings of this specification, may affect numerous modifications thereto and changes may be made without departing from the scope and spirit of the invention in its aspects.

Any other undisclosed or incidental details of the construction or composition of the various elements of the disclosed embodiment of the present invention are not believed to be critical to the achievement of the advantages of the present invention, so long as the elements possess the attributes needed for them to perform as disclosed. The selection of these and other details of construction are believed to be well within the ability of one of even rudimental skills in this area, in view of the present disclosure. Illustrative embodiments of the present invention have been described in considerable detail for the purpose of disclosing a practical, operative structure whereby the invention may be practiced advantageously. The designs described herein are intended to be exemplary only. The novel characteristics of the invention may be incorporated in other structural forms without departing from the spirit and scope of the invention. The invention encompasses embodiments both comprising and consisting of the elements described with reference to the illustrative embodiments. Unless otherwise indicated, all ordinary words and terms used herein shall take their customary meaning. All technical terms shall take on their customary meaning as established by the appropriate technical discipline utilized by those normally skilled in that particular art area.

What is claimed is:

1. An in-line industrial device comprising:
a hopper, wherein the hopper includes a fluidizing plate connected to an air supply;
one or more feed pumps coupled to the hopper;
a pressure sensor coupled to the one or more feed pumps and the hopper;
a flowmeter coupled to the one or more feed pumps, the pressure sensor, and the hopper;
a pressure regulator coupled to the hopper;
a level sensor coupled to the hopper;
a first controller electrically connected to the one or more feed pumps, the pressure sensor, the flowmeter, the pressure regulator, and the level sensor, wherein the first controller is configured to adjust the one or more feed pumps and the pressure regulator based on the pressure sensor, the flowmeter, and level sensor; and
one or more tilt tables, each comprising:
an airbag having a dynamic volume of air;
a plurality of tilt table sensors;
a second controller electronically connected to the airbag, the plurality of tilt table sensors, and the first controller, wherein the second controller is configured to adjust the volume of air within the airbag based on the plurality of tilt table sensors and the first controller; and
wherein, the hopper receives a supply of powder from the plurality of tilt tables via a powder intake.

2. The in-line industrial device of claim 1, wherein the hopper is configured to continuously supply the powder to the in-line industrial device for use in an electrostatic coating system.

3. The in-line industrial device of claim 2, wherein the hopper is configured with smooth internal contours to prevent powder accumulation, particle segregation, settlement, and caking of the powder.

4. The in-line industrial device of claim 3, wherein the hopper is accessible to inspection and maintenance by opening a lid of the hopper.

5. The in-line industrial device of claim 1, wherein the level sensor measures the level of powder within the hopper and the first controller modulates the flow of powder into the hopper based on the level sensor measurement.

6. The in-line industrial device of claim 5, wherein the hopper further comprises an integrated weighing scale to allow for precise measuring of powder levels within the hopper.

7. The in-line industrial device of claim 1, wherein the one or more feed pumps each include a shutoff valve that when actuated, prevents the flow of the powder through the one or more feed pumps.

8. The in-line industrial device of claim 7, wherein the one or more feed pumps are evenly spaced apart to limit segregation, settlement, caking, and uneven drawings of the powder.

9. The in-line industrial device of claim 8, wherein the one or more feed pumps comprise up to 10 feed pumps.

10. The in-line industrial device of claim 1, wherein the pressure sensor and flowmeter measure the air supply to the one or more feed pumps.

11. The in-line industrial device of claim 10, wherein the hopper further comprises an exhaust port that is connected to the first controller and the first controller modulates the flow of air supply through the exhaust port to maintain optimal operating conditions within the hopper.

12. The in-line industrial device of claim 11, wherein excess air supply is released through the exhaust port when one of the pressure, humidity, and temperature within the hopper exceeds a desired measurement.

13. The in-line industrial device of claim 1, wherein the first sensor comprises a display.

14. The in-line industrial device of claim 1, wherein the hopper further comprises an RFID tag which corresponds with an RFID receiver included in the plurality of tile tables.

15. The in-line industrial device of claim 14, wherein the RFID tag includes unique material specifications and the plurality of tilt tables utilize the unique material specifications to set system parameters of the in-line industrial device.

16. The in-line industrial device of claim 1, wherein the plurality of tilt tables each further comprise a powder storage container disposed along a surface of the tilt tables.

17. The in-line industrial device of claim 16, wherein the plurality of tilt tables modulate the flow of powder from the powder storage container.

18. The in-line industrial device of claim 16 further comprising a vibration sensor to monitor the components of the in-line industrial device and determine whether the in-line industrial device is clogged or caked.

19. The in-line industrial device of claim 1, wherein the hopper and the tilt table are operatively connected to provide a seamless and continuous flow of powder through the in-line industrial device.

20. The in-line industrial device of claim 19, further comprising a batch planner, wherein the batch planner is configured for a user to send and receive instructions from the in-line industrial device.
